(19) United States
(12) Patent Application Publication
(10) Pub. No.: US 2013/0238383 A1
(43) Pub. Date: Sep. 12, 2013

(54) AUTO-ADJUSTING WORKER CONFIGURATION FOR GRID-BASED MULTI-STAGE, MULTI-WORKER COMPUTATIONS

(71) Applicant: CALLIDUS SOFRWARE INCORPORATED, Pleasanton, CA (US)

(72) Inventors: Vincent Licari, Redwood City, CA (US); Ravindar Roopreddy, Fremont, CA (US)

(73) Assignee: Callidus Sofrware incorporated, Pleasanton, CA (US)

(21) Appl. No.: 13/689,004

(22) Filed: Nov. 29, 2012

Related U.S. Application Data
(60) Provisional application No. 61/578,205, filed on Dec. 20, 2011.

(51) Int. Cl. G06Q 10/06

(52) U.S. Cl. CPC G06Q 10/0633; H04L 47/70
USPC 705/7.27; 709/226

(57) ABSTRACT

A method of improving the operational efficiency of segments of a data pipeline of a cloud based transactional processing system with multiple cloud based resources. The Method having a first step to virtually determine an approximation of a processing runtime of computations computing a value from transactions using potentially available resources of said cloud based transactional processing system for processing segments of a pipeline of data wherein said data comprising compensation and payment type data. A second step to determine an actual processing runtime of computations computing a value from actual transactions using actual available resources using available resources for processing segments of a pipeline of data wherein said data comprising compensation and payment type data. A third step for adjusting a difference between the approximation of the runtime of said first step and the actual processing runtime of said second step by changing material parameters at least including the volume of transactions and available resources at particular segments of the pipeline, to produce an optimum result in adjusted processing runtime.

### CROSS-REFERENCE TO RELATED APPLICATIONS

This application claims the benefit of provisional Patent Application Ser. No. 61/578,205, filed Dec. 20, 2011. Both applications are assigned to the assignee of the present application, and incorporated herein by reference.

### FIELD OF THE INVENTION

The present invention relates generally to grid-based application workflows in a flexible pipeline architecture, and more specifically to dynamically optimizing grid resource usage in a multi-stage operation by using data to perform calculations within each stage, and outputting the results of each stage to the subsequent stage and in the case of the first stage, performing calculations based on an initial set of data.

### RELATED ART

In a grid computation environment, particularly when executing multiple routines at any given time the customary approach has been to dedicate a fixed set of resources for each of the routines so as not to interfere with other routines executing. However, with increased data generation and stored such fixed pathway structure leads to inefficient execution time when large data sets are being processed. Hence, while in the past such fixed architecture has proved to be efficient and easy to develop and add to with multiple customers in an on-demand or server side environment because of the ever increasing complexities of instruction sets to execute a large data set for a particular customer an ever increasing amount of resources are needed. Further, the model of having a fixed set of resources for a particular pipeline operation has proved to be inefficient not only from resource allocation perspectives but also from the need for intermittent fast execution and cost basis when dedicated resources are left idle.

A pipeline computation shall be defined as a number of sequential computational phases that begins processing a various amount of multidimensional data, where the output of one computational phase, being a various amount of processed multidimensional data, will be the input to the next computational phase in the sequence, until all of the multidimensional data has been sequentially processed through all of the computational phases, yielding a various amount of resultant multidimensional data.

There is a need for a non-fixed pipeline architecture for pipeline computations that allows for the flexibility of using distributed resources to reduce complex processing time of data sets while still enabling prioritization of resources for chosen customers.

There is a need for a resource allocation model for pipeline computations using for faster processing times during peak hours using idle resources dedicated to other customers to make up for the lag time while not interfering with already in use or about to be used resources with other customers.

Finally, there is a need for a business model to charge customers for allocation of additional resources for pipeline computations in order to enable them to have results generated from faster processing of data sets.

### SUMMARY OF THE INVENTION

The present invention is directed to a method of improving the operational efficiency of segments of a data pipeline of a cloud based transactional processing system with multiple cloud based resources. The present invention has a first step to virtually determine an approximation of a processing runtime of computations computing a value from transactions using potentially available resources of said cloud based transactional processing system for processing segments of a pipeline of data wherein said data comprising compensation and payment type data. A second step to determine an actual processing runtime of computations computing a value from actual transactions using actual available resources using available resources for processing segments of a pipeline of data wherein said data comprising compensation and payment type data. A third step for adjusting a difference between the approximation of the runtime of said first step and the actual processing runtime of said second step by changing material parameters at least including the volume of transactions and available resources at particular segments of the pipeline, to produce an optimum result in adjusted processing runtime.

The present invention is additionally directed to a method of determining incentive based compensation. It includes modeling a pipeline using a grid configuration for workers having a set of incentive based characteristics being associated with each of the workers and Allocating resources for each of the workers in the grid configuration for processing with the incentive based characteristics through the modeled pipeline. Additionally, Modeling a set of rules associated with the incentive based characteristics for the workers using resources of the grid configuration and figuring out the runtime for processing both the rule set and characteristics of the workers through the modeled pipeline. Also, there is an ascertaining an actual runtime of a pipeline using a grid configuration for workers having a set of incentive based characteristics being associated with each of the workers. Then Determining an allocation of resources for each of the workers in the grid configuration for processing with the incentive based characteristics through the modeled pipeline, and Determining a set of rules associated with the incentive based characteristics for the workers using resources of the grid configuration and the actual runtime for processing both the rule set and characteristics of the workers through the modeled pipeline.

### BRIEF DESCRIPTION OF THE DRAWINGS

FIG. 1 shows a block diagram of a computational pipeline according to an embodiment of the present invention.

FIG. 2 shows a table of stages, rules processed, and actions according to an embodiment of the present invention.

FIG. 3 shows a system level architecture for the multiple connections in the pipeline computational process according to an embodiment of the present invention.

FIG. 4 shows a system level block diagram of an embodiment of the present invention.

FIGS. 5A-E are flowcharts of the provisioning and grid requirements of the multi-grid configuration for processing the computational pipeline according to an embodiment of the present invention.

### DETAILED DESCRIPTION

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The basis for this invention is an auto-configuring distributed computing grid where a pipeline computation will begin with a various amount of data, have each computational phase produce a various amount of data and yield a various amount of resultant data, as described above, yet complete the total pipeline computation in a specified amount of time by dynamically allocating its resource usage for each computational phase.

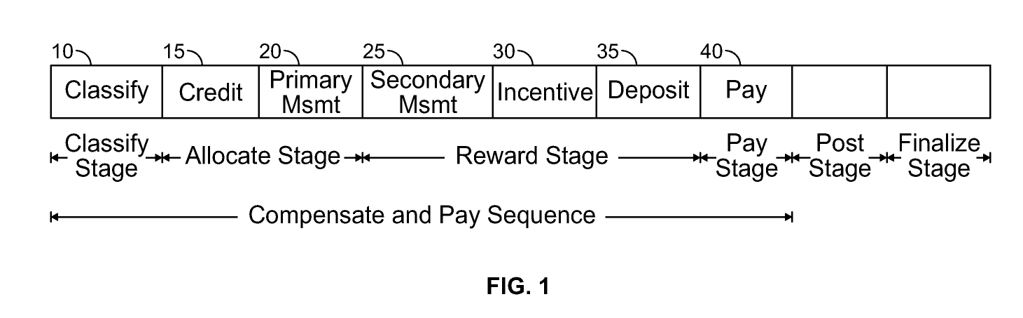

With reference to FIG. 1 a block diagram of a pipeline is shown in accordance with a preferred embodiment of the present invention. The pipeline 10-40 pipeline is a computation engine that performs processing tasks to validate and transfer data, calculate compensation, and create payments. The pipeline 10-40 processes order, transaction, and reference data (compensation plans, participants, positions, territories, quotas, etc.) to calculate compensation. Typically, data is imported in the form of orders received and transaction data. In addition, for some organizations, credit data 15 may also be imported from an outside system. The end result of pipeline processing is a payment 40 amount for each position assignment for the specified period. Payments are then exported to a payroll system. A pipeline is typically run to calculate compensation and payments at least once per given period.

During a pipeline run the computation engine processes data in stages, each of which takes input data, performs actions based on the rules for that stage, and produces output data. The output of each stage is used as input to the next stage in the sequence. A sequence in this instance is a set of one or more pipeline stages.

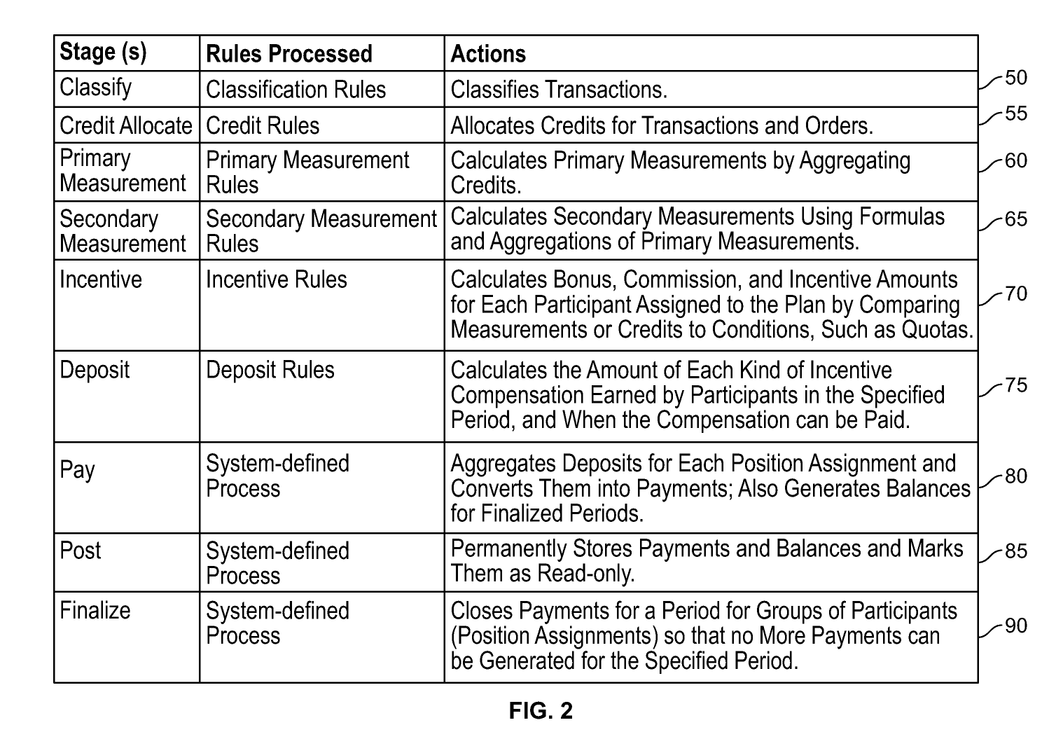

FIG. 2 illustrates a table containing each of the pipeline stages. An individual pipeline stage may be run independently, or an entire sequence including all of the stages may be run. Each stage corresponds to a set of rules which belong specific to a particular stage. The rules are applied within each stage, and the actions that occur (shown in FIG. 2) result from the rules applied (55 to 75) in the table.

Beginning with the Classify Stage 50, transactions which were previously stored in a repository are input to the Classify Stage. The Classify Stage 50 uses clarification rules 5565 to determine how to bundle the transactions using categories, and the output of the Classify Stage 50 is classified transactions. During the Classify Stage 50, transactions are grouped in meaningful ways. For example, product, geography, channels, and customers is one way to group the transactions. Grouping the transactions advantageously allows for more efficient and effective processing of the transactions. For example, when assigning credits for transactions to a set of participants, it may be faster and easier to identify such participants by their workplace location, or customer grouping. Classification rules are different from the other rules because they are not assigned to a particular plan.

Credit Stage 55 calculates credits and then allocates the calculated credits to positions. In this instance, a credit is a value that may be allocated to either the transaction or the order itself. Credit Stage 55 differentiates between two types of credits: direct and rolled. A direct credit is allocated to the sales representative who is directly responsible for the transaction, while a rolled credit is allocated to others as defined by roll relationships. The input for Credit Stage 55 is the classified transactions which were the output from Classify Stage 50. The output for Credit Stage 55 consists of calculated credits for each position assignment. Primary Measurement Stage 60 calculates primary measurements by aggregating credits from Credit Stage 55. The calculated credits from Credit Stage 55 are the input for Primary Measurement Stage 60, and the output of Primary Measurement Stage 60 are primary measurements for each position assignment. The primary measurements are an aggregate of credit amounts that were specified by the user for each position assignment.

For Secondary Measurement Stage 65, the pipeline calculates secondary measurements using one of two methods: a) calculating values based on formulas; or b) aggregating primary measurements based on secondary measurement rules. For example, many companies create a secondary measurement rule to calculate a measurement called attainment, calculated by dividing the sum of primary measurements by a quota. The attainment value can then be used in rate tables used by rules in the incentive stage to calculate award amounts based on different rates of attainment. The input to Secondary Measurement Stage 65 is primary measurements for each position assignment (output of Primary Measurement Stage 60), and the output of the stage is secondary measurements for each position assignment.

Incentive Stage 70 calculates potential earnings (incentives and commissions) by comparing primary measurements or secondary measurements against the incentives for each position assignment in a compensation plan. The input to Incentive Stage 70 is primary and secondary measurements for each position assignment. The output of Incentive Stage 70 is incentives associated with each position assignment.

Deposit Stage 75 calculates incentives which are to be paid and converts them into deposits. A deposit is the amount of compensation calculated for a position for the period for which the pipeline is run. Pipeline calculates the amount of incentive earnings deposited as well as when the deposit may be made. For example, a user may wish to hold deposits that are associated with an unpaid customer invoice. In the alternative, a user may wish to hold deposits that exceed a maximum earnings policy for a product. In addition, in establishing deposit rules, a user may also specify conditions for a hold, as well as the release date. The input to Deposit Stage 75 is the incentive amount from each position assignment. The output of Deposit Stage 75 consists of deposit amounts and the dates of each payment.

The deposit amounts and payment dates output from Deposit Stage 75 are input to Pay Stage 80, where pipeline aggregates the deposits for each position assignment and converts those that are ready to be paid into trial payments. Deposits are associated with current period earnings, while payments represent incremental earnings for the period plus any balances from prior period earnings. The output of Pay Stage 80 is trial payments for non-finalized periods, and trial balances for finalized periods.

The trial payments and trial balances output from Pay Stage 80 are input to Post Stage 85 where they are permanently stored and marked “posted”. Each posted payment represents a check that will be paid to a participant or user. Both the posted payments and balances are output from Post Stage 85 and input to Finalize Stage 90. In Finalize Stage 90, pipeline closes payments for a specified period. Balances are then calculated for all closed positions. In addition, any negative incremental deposits that remain may be converted to a negative balance at this point.

The pipeline includes each of the stages described above (Classify Stage 50, Credit Stage 55, Primary Allocate Stage 60, Secondary Measurement Stage 65, Incentive Stage 70, Deposit Stage 75, Pay Stage 80, Post Stage 85, and Finalize Stage 90). To calculate compensation or create payments, one or more of the pipeline stages must be run. For the most efficient pipeline operation, a particular segment may be run. A segment consists of multiple stages which are consecutively run. In a preferred embodiment, pipeline contains a total of three segments (not shown), each of which are driven by different kinds of processes: 1) Classify segment; 2) Compensation segment; and 3) Pay, post, and finalize segment. The Classify segment operates based on user-defined classification rules. The Compensation segment (shown in FIG. 1) operates based on user-defined compensation rules and consists of Credit Stage, Primary Allocate Stage 15-20, Secondary Measurement Stage 25, Incentive Stage 30, and Deposit Stage 35. The Pay, post, and finalize segment differs from both the Classify segment and the Compensation segment because it is driven by system-defined processes instead of the user-defined rules which form the basis of the other segments.

The first part of the process to is to theoretically determine the time that the pipeline processing is to take. There are three types of pipeline computational methods and a determination is made with respect to the amount of data i.e. input stage, the amount of conditions and the amount of resources (the classify to the pay stages) as to which method is the optimum method to use. Hence, an user can subjectively decide which method is most application with to determine the processing times vs. data amounts, and use the following methodology:

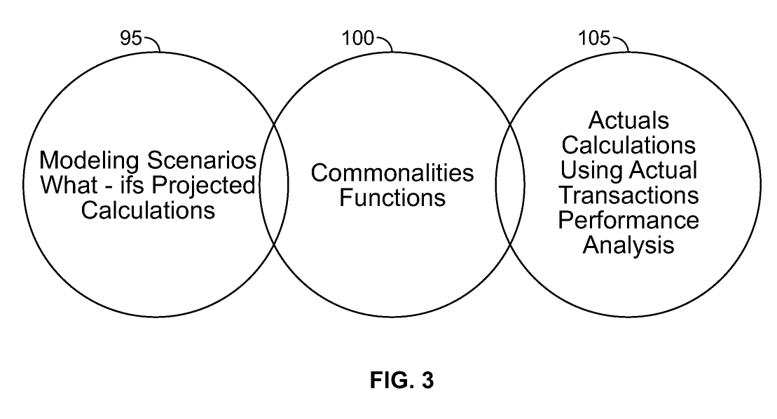

1) Computational phases (with reference to FIG. 3 block 95) where the data amount processed contributes in a linear manner to the processing time will be shown as:

T1=L(v*n)
i. T1=processing time
ii. v=a data amount unit
iii. n=a number of units
iv. L=a linear function

As shown in the equation above there are 4 factors that determine the processing time T1 and there are proportional to the amount of data units V, the number of the data units N, and the linear function; this is basically that the upon an increase in the V,N the linear function which processes the units on a case by case basis increases in time exponentially.

A second scenario is when computational phases where the data amount processed contributes to some factor of processing time will be shown as:

T2=F(v*n)
i. T2=processing time
ii. v=a data amount unit
iii. n=a number of units
iv. F=a non-linear function

In the second scenario the processing time 12 is calculated by a data amount unit V, a number of units N, and a non-linear function of the units F. If there is a non-linear function that the time allocation is proportional to the non-linear amount from the function.

Computational phases where various data amounts will be processed in a constant processing time will be shown as:

T3=C(T3)
i. T3=processing time
ii. C=a constant function

With phases B, D and F being Constant time phases and to arrive at this run time approximation, the amount of time from the phases with linear functions (T1) and non-linear functions (T2) will be computed and summed. Their combined time (Tc=T1+T2) establishes the time required to process data amounts where the processing time is determined by the data amounts. Subtracting Tc from the amount of time specified to complete the pipeline computation (Ta) results in the time remaining to completion (Tr=Ta−Tc). The value of Tr will then be divided. Among the Constant time phases, however, each Constant time phase may not contribute equally to Tr but their sum will equal Tr.

The above three methods all use a determination of the processing time, and the processing time or run time can be figured out using the below equation and then then entire processing of the pipeline can be determined by one of the above three methods. The equation is as follows:

Ta=Σ1SaL(Va*Na)+Σ1SbF(Vb*Nb)+Σ1Sc

Fig. A

In the above equation the processing time or Run-Time is determined as follows by referencing Figure A above and with reference to FIG. 3 block 100. As an example, during the run-time (or actuals with reference to FIG. 3, block 105), phase A may have produced a larger or smaller data amount than estimated and may have taken 8 minutes instead of the approximated 5 minutes to complete. The time remaining to complete Phase B within its projected target time will now be 15 minutes instead of 18 minutes. Phase B will make the necessary distributed computing adjustments to complete processing in 15 minutes. Both phase B and phase C's processing time and data amount estimates may or may not be on target with the actuals, but phase D will make the necessary adjustments to complete at its target time (this goes for being both behind schedule and ahead of schedule). This continues until all phases have been processed which will result in a run completion time very close to the specified amount of time given. C(T) Single Computation Grid shared by multiple tenants.

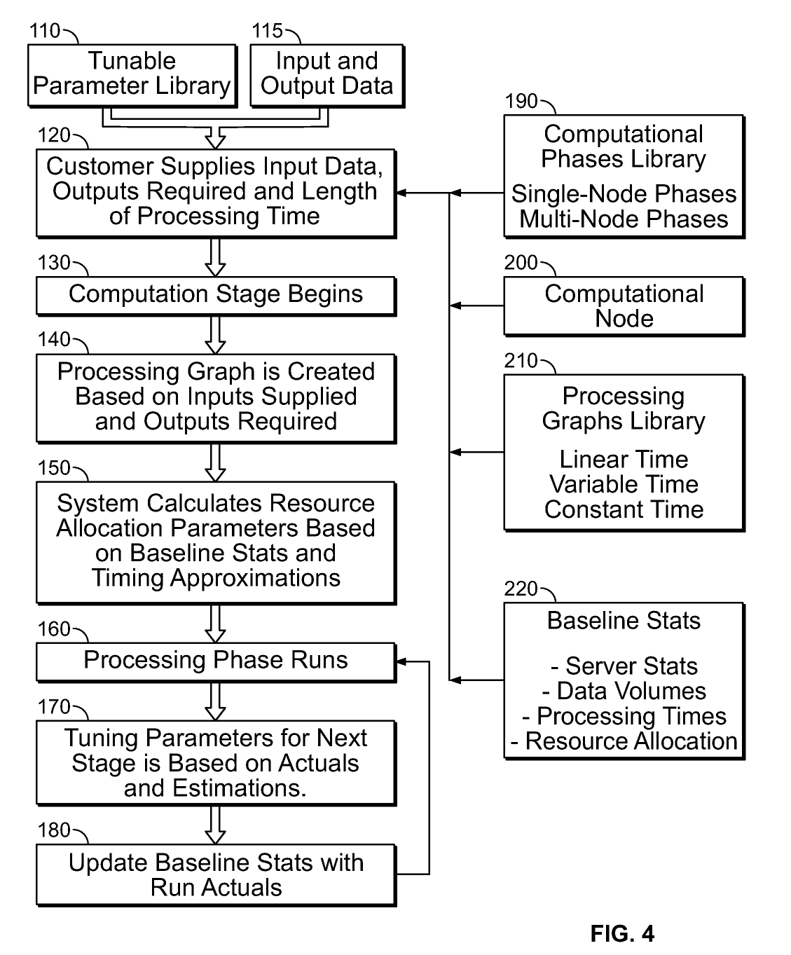

As shown in FIG. 4, there is a parameter library 110 and input/output data 115 combined to customer supplies input data outputs required and length processing time 120. It should be noted that the computational phase is when a computing algorithm applied to input data that yields output data. The computational node is a Java Virtual Machine (“JVM”) process that runs a Computational Phase and the Distributed Computing Grid is a grouping of physical servers 190 that run one or more Computational Nodes 200. During a Multi-Node Phase is when more than one Computational Node (of the same Computational Phase) run concurrently where each Node processes a subset of the total input data and yields a subset of the output data until the total input data has been processed yielding the total output data.

Next, the single-Node Phase 190 is a single Computational Node that processes the total input data and yields the total output data. The Computing Stage 130 is a predefined sequence of Single-Node and Multi-Node Computational Phases, where each Phase executes a unique computing algorithm, with each Phase in the sequence using the output data of the previous Phase as its input data (with the exception of the first Phase whose input data is supplied by the customer). The Distributed Computing Adjustments are the Phases with Constant processing time are Single Job queue shared by multiple tenants 140. The Jobs for different tenants can run in parallel to each other.

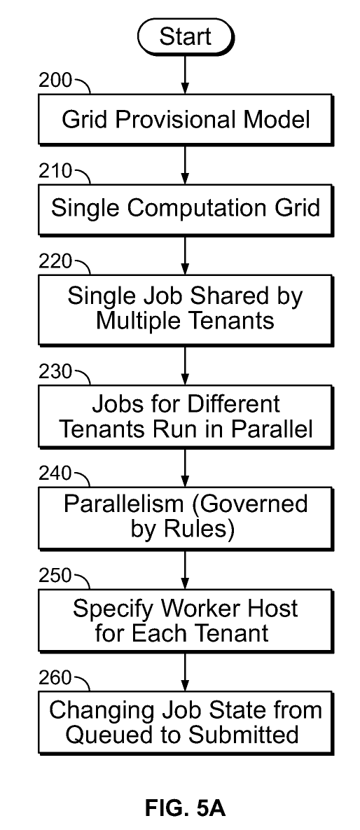

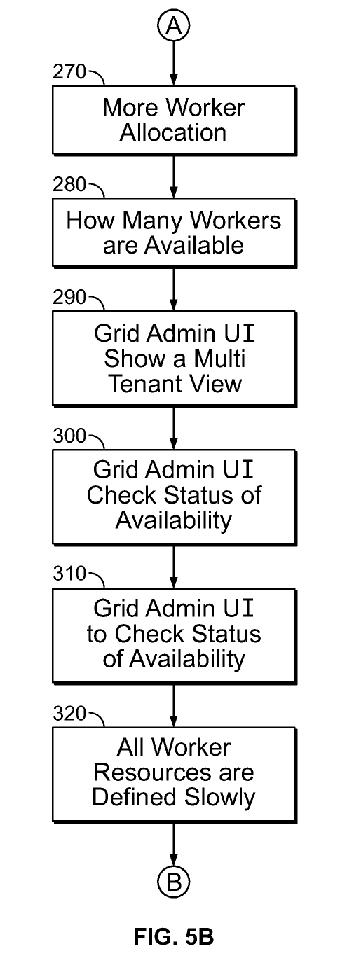

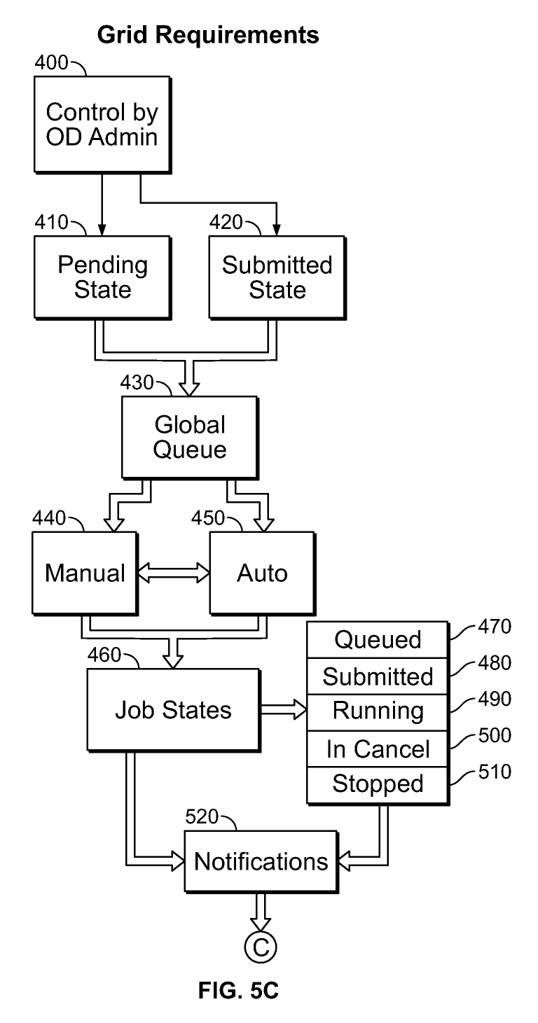

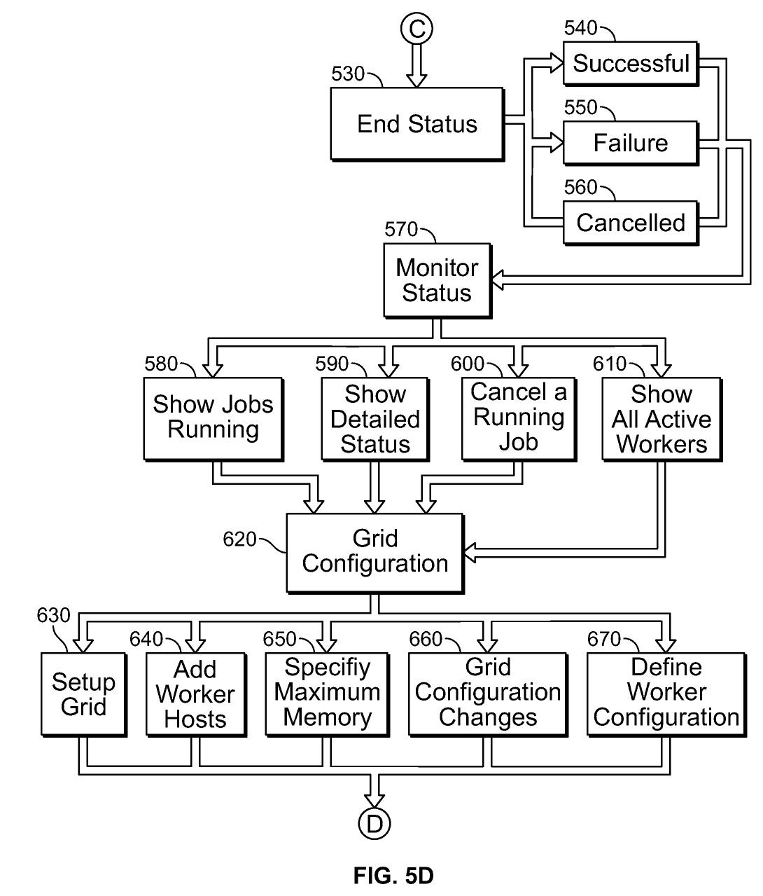

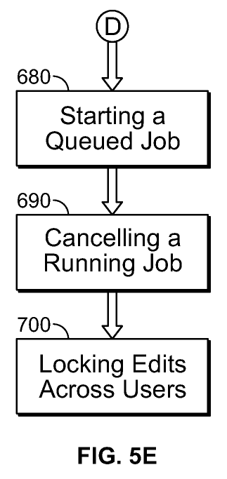

As shown in FIG. 5a, the grid provisional model includes a single computational grid 210, a single job shared by multiple tenants 220, jobs for different tenants run in parallel 230. With reference to FIG. 5a, parallelism 240 within the tenant is still governed by current rules i.e. two exclusive jobs cannot be run parallel for a given tenant. There is no static pooling of worker resources. All workers get assigned for a given Computation run at runtime by the OD Administrator. In today's Grid, OD Admin has to specify worker host resources for each tenant to use 250. Worker resource allocation to a Job happens as a part of changing a job state from Queued to Submitted 260, done by OD Administrator. Additionally, there is a need to have a staging queue where all the submitted jobs are queued by submit time. OD Admin will start the jobs manually and specifying which worker resource 270 to use and when the operation should begin for example during night time and the worker resource who is to start the job 280. Next, there is an auto mode where jobs are to be run based on priority in a FIFO round robin fashion. Hence, jobs are routed according to those jobs first submitted and to the jobs last submitted.

More worker resources can be allocated to an already running Pipeline Run at run time based on the availability of resources. Users should be able to startup a Grid Service and it will join the Grid automatically. i.e. once Grid Services is started, the machine should be available for worker resource allocation. A concern here is the how many worker resources can be allocated to a machine or what is the total number of worker resources that a machine can hold. The OD Administrator can specify by user or worker allocation number or by the Grid Service and then can figure out the architecture and available memory for the machine.

The Grid Administrator User Interface 300 shows a multi-tenant view of the Jobs and Worker Resources. The Grid Admin UI is generally displayed in a tile layout with all the available workers and their status. This Grid Admin UI 310 should show how many workers are available and how many are used for a particular host instead of showing worker itself. Grid Admin UI 310 to check the status of availability of worker resources i.e. which worker VMs are busy and which ones are idle. All worker resources are defined globally across tenants i.e. run n workers on Host X, run n workers on Host Y without any association with tenant. Worker failure will not bring down the run. The portion of the job that was being processed by the worker, gets picked up by other workers. This only works for Allocate partially.

The grid requirements for the pipeline allocation process are shown in FIG. 5c and require the following: the OD Administrator should control 400 when a Job goes from Pending State 410 to Submitted State 400, given the availability of worker resources. All Jobs run from command line or UI are always queued up in a global Job Queue. Job Queue will run in two modes: Manual 440—In this mode all incoming Jobs are queued in the Job queue and do not start until marked as Runnable by OD administrator. Auto 450—In this mode all incoming jobs are queued in the Job queue but the Job Queue Manager will start the job at the top of the queue if resources are available.

A Job can go through following states: —Queued 470. This is when a job is Submitted 480. (when the job is marked as Runnable manually be OD admin or in case of Auto Mode when Job Queue Mgr. puts it in Runnable mode) 490; Running In-cancel (for a cancelled job only) 500 and Stopped 510.

Notification system 520 will let OD Administrator configure a set of email addresses to be notified when a Job comes in. A Job can have one of the following End Status at the end of the run 530: —Successful 540, Failed 550 and Cancelled 560.

The OD Administrator can Monitor activity across the Grid 570: such monitoring would include—Phases with Constant processing time are Multi-Node Phases that utilize various amounts of distributed 580; Computing resources such that the processing of various data amounts will complete in the amount of time calculated for the phase 590. This is accomplished by adjusting the number of Computational Nodes per Multi-Node Phase. Since a Computational Node is a JVM, the total amount of RAM used by the JVM also needs to be calculated for each Node. Since a physical server has a specific amount of RAM, the number of concurrently running Nodes on a physical server is therefore limited by the RAM allocated for each Node and the amount of specific RAM on the server.

The total number of concurrently running Nodes in the Grid is therefore the total number of Nodes that can be run on each server for each server that's in the Grid. Nodes will be allocated on each server using a “best fit” calculation to maximize the number of Nodes that can run concurrently given the RAM usage of each Node.

Since servers contain multi-core CPUs, another calculation will also limit the number of concurrent Nodes to not over utilize the number of cores on each server. Since any Phase of a Computing Stage can be simultaneously running on any server in the Grid (since many concurrent pipeline computations can be running), this Adjustment calculation will also consider the CPU load imposed by a Phase.

The Distributed Computing Adjustments take into account both RAM and CPU usage of each Computational Phase and its partial allocation of overall server resources within the Grid when calculating the computing resources required to complete the computation in a specified amount of time Show all running jobs. Below is the pipeline report showing an example of the computation of resources.

Report A

| | | | | | | |
|---|---|---|---|---|---|---|
| Submit | Tenant | Command | Argu- | Status | Progress | Error |
| Date | Id | | ments | | | Count |

For example from the about report (See Report A above), there is seen all pending jobs 580 and show detailed status of a given Job such as a Cancel a running job 600. Additionally there is shown all active workers on all Worker Hosts; Grid Configuration 620; Set up Grid Server 630; Added Worker Hosts Specify number of workers on a Host 640 and Specify maximum memory 670 for each worker. Minimum memory will be a global default but if the OD Admin wants, it can edit that too 660.

Grid Configuration changes 660 require Grid Restart. Define worker configuration for a Tenant 670. Starting a Queued Job 680. OD Administrator can start a queued Job by selecting that Job and click on Start button. OD Admin is taken to the UI to override worker resources for the Job being started, if needed. In case the OD admin wants to start the run by overriding static worker configuration, OD Admin can view a list of Worker Resources that are available for allocation. Cancelling a Running Job. OD Administrator can cancel a running job 690 by selecting that job and clicking Cancel button.

The job being cancelled will go from state Running to In-Cancel. Once the job is successfully cancelled, the workers allocated to the job will become idle and once again available for allocation. The job will change its state to Stopped with Status Cancelled.

Locking Edits 700 across multiple users and Editing of Grid Configuration will require obtaining a lock before editing Grid Configuration so that multiple users don't overwrite each other's changes. Starting a Job will also put the job in the exclusive lock so that some other OD Admin user may not be able to start it at the same time as well. The lock will be removed once the job is successfully started. Cancel job will go through exclusive locking process like the one for Starting a Job.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method of improving the operational efficiency of segments of a data pipeline of a cloud based transactional processing system with multiple cloud based resources comprising:
a first step to virtually determine an approximation of a processing runtime of computations computing a value from transactions using potentially available resources of said cloud based transactional processing system for processing segments of a pipeline of data wherein said data comprising compensation and payment type data;
a second step to determine an actual processing runtime of computations computing a value from actual transactions using actual available resources using available resources for processing segments of a pipeline of data wherein said data comprising compensation and payment type data; and
a third step for adjusting a difference between the approximation of the runtime of said first step and the actual processing runtime of said second step by changing material parameters at least including the volume of transactions and available resources at particular segments of the pipeline, to produce an optimum result in adjusted processing runtime.

2. The method of claim 1, wherein the approximation of the runtime is based on parameters.

3. The method of claim 1, wherein if the difference between the approximation of the runtime and the actual runtime of the first and second stages is too large, a tuning is performed by changing the material parameters.

4. The method of claim 1, wherein the approximation is based on resources that are currently available.

5. The method of claim 1, wherein the first stage and the second stage are driven by user-defined rules.

6. The method of claim 1, wherein the third stage is driven by system-defined processes.

7. A computer program in a computer readable storage medium for determining a pipeline for processing calculations of incentive based compensation comprising:
Program code for defining a first step to virtually determine an approximation of a processing runtime of computations computing a value from transactions using potentially available resources of said cloud based transactional processing system for processing segments of a pipeline of data wherein said data comprising compensation and payment type data;
Program code for defining a second step to determine an actual processing runtime of computations computing a value from actual transactions using actual available resources using available resources for processing segments of a pipeline of data wherein said data comprising compensation and payment type data; and
Program code for defining a third step for adjusting a difference between the approximation of the runtime of said first step and the actual processing runtime of said second step by changing material parameters at least including the volume of transactions and available resources at particular segments of the pipeline, to produce an optimum result in adjusted processing runtime.

8. The method of claim 7, wherein the approximation of the runtime is based on parameters.

9. The method of claim 7, wherein if the difference between the approximation of the runtime and the actual runtime of the first and second stages is too large, tuning is performed by changing the material parameters.

10. The method of claim 7, wherein the approximation is based on resources that are currently available.

11. The method of claim 7, wherein the first stage and the second stage are driven by user-defined rules.

12. The method of claim 7, wherein the third stage is driven by system-defined processes.

13. A method of determining incentive based compensation, comprising:
Modeling a pipeline using a grid configuration for workers having a set of incentive based characteristics being associated with each of the workers,
Allocating resources for each of the workers in the grid configuration for processing with the incentive based characteristics through the modeled pipeline, and
Modeling a set of rules associated with the incentive based characteristics for the workers using resources of the grid configuration and figuring out the runtime for processing both the rule set and characteristics of the workers through the modeled pipeline.

14. A method according to claim 13, comprising:
Ascertaining an actual runtime of a pipeline using a grid configuration for workers having a set of incentive based characteristics being associated with each of the workers,
Determining an allocation of resources for each of the workers in the grid configuration for processing with the incentive based characteristics through the modeled pipeline, and
Determining a set of rules associated with the incentive based characteristics for the workers using resources of the grid configuration and the actual runtime for processing both the rule set and characteristics of the workers through the modeled pipeline.

15. A method according to claim 14, comprising
Comparing the modeled runtimes to the actual runtimes and changing the grid configuration to adjust the resources associated with the workers to allow the actual runtimes to be closer to the modeled runtimes.

16. A method according to claim 15, comprising
Changing a set of material parameters in the grid configuration to change the actual runtimes to enable the processing material characteristics and the set of the rules associated with the workers to a predetermined runtime.

17. A method according to claim 16, comprising
Changing memory allocations with the resources associated with the workers to change the actual runtimes.
